(19) United States
(12) Patent Application Publication
(10) Pub. No.: US 2014/0268910 A1
(43) Pub. Date: Sep. 18, 2014

(54) COUPLED INDUCTOR DC STEP DOWN CONVERTER

(71) Applicant: Flextronics AP, LLC, Broomfield, CO (US)

(72) Inventor: Wei Li, Shenzhen (CN)

(21) Appl. No.: 13/867,908

(22) Filed: Apr. 22, 2013

Related U.S. Application Data
(60) Provisional application No. 61/798,836, filed on Mar. 15, 2013.

(51) Int. Cl. H02M 3/335

(52) U.S. Cl. CPC H02M 3/33546
USPC 363/21.04

(57) ABSTRACT

A step down power converter include a switch, an inductor, a diode, a capacitor, and a winding magnetically coupled to the inductor. The diode, the inductor and the capacitor are coupled in series, and the transistor, the coupled winding and the capacitor are coupled in series. An output voltage Vout is supplied across the capacitor. When the switch is ON, energy is transferred from an input supply voltage to a load coupled across the capacitor, and current flows through the coupled winding thereby storing energy in the winding. When the switch OFF, current does not flow through the coupled winding, but the energy stored in the winding induces current in the magnetically coupled inductor, thereby delivering energy from the winding to the load.

### RELATED APPLICATIONS

This patent application claims priority under 35 U.S.C. 119 (e) of the co-pending U.S. Provisional Application Ser. No. 61/798,836, filed Mar. 15, 2013, and entitled “LASER MEASUREMENT SYSTEM AND METHOD IN A CNC MACHINE”. This application incorporates U.S. Provisional Application Ser. No. 61/798,836 in its entirety by reference.

### FIELD OF THE INVENTION

The present invention is generally directed to the field of power converters. More specifically, the present invention is directed to a new power converter architecture having increased efficiency.

### BACKGROUND OF THE INVENTION

There are several power converter topologies that have been developed over the years, which are intended to improve the power density and switching efficiency of power converters. An emerging focus of new converter topologies is to provide a means to reduce or eliminate converter switching losses, while increasing the switching frequencies. Lower loss and higher switching frequency means more efficient converters, which can reduce the size and weight of converter components. Additionally, with the introduction of high speed composite semiconductor switches, such as metal oxide semiconductor field effect transistor (MOSFET) switches operated by pulse width modulation (PWM), recent forward and flyback topologies are now capable of operation at greatly increased switching frequencies, such as, for example, up to 1.0 MHz.

However, an increase in switching frequency can cause a corresponding increase in switching and component stress related losses, as well as increased electromagnetic interference (EMI), noise, and switching commutation problems, due to the rapid ON/OFF switching of the semiconductor switches at high voltage and/or high current levels. Moreover, modern electronic components are expected to perform multiple functions, such as provide for variable step-up or step-down voltage transformation.

The different types of power converter topologies can be used in a wide variety of applications. Light emitting diode (LED) technology is being used in ever expanding applications. To implement LED lighting, high efficiency LED drivers are needed to obtain overall power conversion from line voltage to load voltage that is applied to an LED bulb lighting. A common function of power converters is to provide for isolation of the output or “load” voltage from the input or “source” voltage. However, such isolation results in reduced power conversion efficiency and increased cost. In an LED bulb lighting application, safety isolation can be achieved using a bulb cover, removing the need for isolation within the LED driver circuit. At present, buck step down converters, non-isolated flyback converters and buck boost converters are common, non-isolating converter circuits used in the LED driver circuit of LED bulb lighting systems. However, such LED driver circuits suffer from power conversion inefficiencies when used in applications where high AC line voltage is converter to low output voltage, for example less than 10V, as in LED bulb lighting applications.

FIG. 1 illustrates a conventional buck step down voltage converter. The converter 10 includes a transistor Q1, an inductor L1 a capacitor C1, and a diode D1. Input voltage to the circuit may be unregulated DC voltage derived from an AC supply after rectification and filtering. The transistor Q1 is a fast-switching device, such as a MOSFET, the switching of which is controlled by a fast dynamic controller (not shown) to maintain a desired output voltage Vout. In operation, the transistor Q1 and the diode D1 alternate between connecting the inductor L1 to the voltage source Vin to store energy in the inductor L1 and disconnecting the inductor L1 from the voltage source Vin to discharge the stored energy in the inductor to a load coupled at the output.

With the transistor Q1 turned ON, current flows from the voltage source Vin through the transistor Q1 and the inductor L1 to the capacitor C1 and the load coupled at the output. When the transistor Q1 is ON, the voltage VL across the inductor L is, VL=Vin−Vout. The current through the inductor L rises linearly. The diode D1 is reverse-biased by the voltage source Vin, and as such no current flows through it. During this period, the inductor L1 is storing energy in the form of a magnetic field. With the transistor Q1 turned OFF, the voltage source Vin is removed from the circuit and the inductor L1 functions as the voltage source with current flowing from the inductor L1 to the capacitor C1 and the load and the forward-biased diode D1. During this period, the inductor L1 is discharging its stored energy into circuit. The capacitor C1 functions to smooth out voltage waveform as the inductor L1 charges and discharges in each cycle.

FIG. 2 illustrates a low-side drive conventional buck step down voltage converter. The buck step down voltage converter shown in FIG. 2 is similar to the buck step down voltage converter in FIG. 1 except that the transistor Q2 is located on the low-side of the circuit instead of the high-side as in the transistor Q1. Configuring the transistor on the low-side simplifies the driver circuit since the source pin of the transistor connects to ground. In contrast, configuring the transistor on the high-side, as in FIG. 1, the high-side transistor source is floating. The output of buck circuit with low side mosfet is floating so it only suitable for the application that doesn't need common ground between input and output side.

The buck converter efficiency is limited by the ratio of the input voltage to the output voltage. Higher voltage ratios results in lower efficiency. At low voltage output which is less than 10V, the forward voltage drop across the freewheeling diode is more than 1V. As such, the diode dissipates 5-10% of the total output power and leads to poor power conversion efficiency.

### SUMMARY OF THE INVENTION

Embodiments of a step down power converter include a switch, an inductor, a diode, a capacitor, and a winding magnetically coupled to the inductor. The power converter receives as input a rectified AC voltage. In some embodiments, the rectified AC voltage is a rectified AC line voltage. A duty cycle of the switch is controlled by a controller coupled to the switch. In some embodiments, the switch is a transistor. The diode, the inductor and the capacitor are coupled in series, and the transistor, the coupled winding and the capacitor are coupled in series. The output voltage Vout is supplied across the capacitor. When the switch is ON, energy is transferred from the input supply voltage to a load coupled across the capacitor, and current flows through the coupled winding thereby storing energy in the winding. When the switch OFF, current does not flow through the coupled winding, but the energy stored in the winding induces current in the magnetically coupled inductor, thereby delivering energy from the winding to the load. The power converter provides improved efficiency for those applications that convert a high AC line input voltage to a lower output voltage, such as less than 10V.

In an aspect, a power converter circuit to convert an input voltage to an output voltage is disclosed. The power converter includes a diode, a first inductor, an output capacitor, a second inductor and a switch. The first inductor is coupled in series with the diode. The output capacitor is coupled to an input supply voltage and coupled in parallel to the serially coupled diode and first inductor. The output voltage is a voltage across the capacitor. The second inductor is coupled in series to the capacitor. The second inductor is magnetically coupled to the first inductor. The switch is coupled in series to the second inductor and the input supply voltage.

In some embodiments, the power converter circuit is configured to transfer energy from the input supply voltage to a load coupled to the capacitor and to store energy in the second inductor when the switch is ON. In some embodiments, the power converter is configured to transfer energy from the second inductor to the load coupled to the capacitor when the switch is OFF. In some embodiments, the diode is reverse-biased and no current flows through the serially coupled first inductor when the switch is ON. In this case, current through the second inductor can rise linearly to a peak value when the switch is turned ON. In some embodiments, the diode is forward-biased and current flows through the serially coupled first inductor when the switch is OFF. In this case, current through the first inductor can decrease linearly when the switch is turned OFF. In some embodiments, a cathode of the diode is coupled to a high side of the input supply voltage and to a first terminal of the capacitor, an anode of the diode is coupled to a first terminal of the first inductor, and a second terminal of the first inductor is coupled to a second terminal of the capacitor. In some embodiments, a first terminal of the second inductor is coupled to the switch, and a second terminal of the second inductor is coupled to the second terminal of the capacitor. In some embodiments, the switch is coupled to a low-side of the input supply voltage. In some embodiments, the switch comprises a transistor. In some embodiments, the power converter also includes a controller coupled to the switch.

In another aspect, another power converter circuit is disclosed. The power converter circuit includes a buck type converter, a winding and a switch. The buck type converter includes a diode, a capacitor, and an inductor, wherein the buck type converter is coupled to an input supply voltage and supplies a stepped-down output voltage across the capacitor. The winding is coupled in series to the capacitor and magnetically coupled to the inductor. The switch is coupled in series to the coupled winding and to a low-side of the input supply voltage. In some embodiments, the power converter can also include a controller coupled to the switch to turn the switch ON and OFF, wherein the power converter circuit is configured such that when the switch is ON current flows through the winding and not the inductor, thereby storing energy in the winding and delivering energy from the input supply voltage to a load coupled to the capacitor, and when the switch is OFF current flows through the inductor and not the winding, whereby the stored energy in the winding induces current in the inductor thereby delivering energy from the winding to the load coupled to the capacitor.

### BRIEF DESCRIPTION OF THE DRAWINGS

Several example embodiments are described with reference to the drawings, wherein like components are provided with like reference numerals. The example embodiments are intended to illustrate, but not to limit, the invention. The drawings include the following figures:

FIG. 1 illustrates a conventional buck step down voltage converter.

FIG. 2 illustrates a low-side drive conventional buck step down voltage converter.

FIG. 3 illustrates a power converter according to an embodiment.

### DETAILED DESCRIPTION OF THE EMBODIMENTS

Embodiments of the present application are directed to a power converter. Those of ordinary skill in the art will realize that the following detailed description of the power converter is illustrative only and is not intended to be in any way limiting. Other embodiments of the power converter will readily suggest themselves to such skilled persons having the benefit of this disclosure.

Reference will now be made in detail to implementations of the power converter as illustrated in the accompanying drawings. The same reference indicators will be used throughout the drawings and the following detailed description to refer to the same or like parts. In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

FIG. 3 illustrates a power converter according to an embodiment. The power converter 10 is configured to receive an unregulated DC voltage signal as input voltage Vin and to provide an unregulated output voltage Vout. Input voltage to the circuit may be unregulated DC voltage derived from an AC supply after rectification. The input voltage is typically filtered, such as via capacitor. In some embodiments, the output voltage level is suitable for many low voltage appliances such as computer laptops, cell phones and other hand held devices. In an exemplary embodiment the output voltage Vout is set at 10V or less. Alternatively, the power converter 10 can provide the output voltage Vout that is greater than 10 VDC.

The power converter 10 is configured as a step down converter. In some embodiments, the power converter is configured to include attributes from a buck type converter. In general, the power converter can include configurations of switch mode power supplies known to a person of skill in the art. The power converter 10 includes a diode 12, a capacitor 14, an inductor 16, a switch 18, a controller 20, and an inductor 22. The diode 12 is coupled in series with the inductor 16, and this coupled series is coupled in parallel to the capacitor 14. The switch 18 is coupled in series with the inductor 22.

The switch 18 is a suitable switching device. In an exemplary embodiment, the switch 18 is a n-type metal-oxide-semiconductor field-effect transistor (MOSFET) device. Alternatively, any other semiconductor switching device known to a person of skill in the art can be substituted for the switch 18. The transistor 18 is controlled by the controller 20 to maintain a desired output voltage Vout. In some embodiments, the controller 20 includes a pulse width modulation (PWM) circuit. The controller 20 regulates the duty cycle of the transistor 18 with the PWM circuit.

The inductor 22 is magnetically coupled to the inductor 16 such that the inductor 22 forms a primary winding and the inductor 16 forms a secondary winding of a transformer TX1. However, a second terminal of the inductor 16 is electrically coupled to a second terminal of the inductor 22. This common terminal is coupled to the capacitor 14. As shown in FIG. 3, the freewheeling diode 12 is coupled to the coupled winding, the inductor 22, instead of the drain of the MOSFET Q2 as in the conventional low side buck converter of FIG. 2.

In operation, with the transistor 18 turned ON, current flows from the voltage source Vin through the capacitor 14, the inductor 22 and the transistor 18. When the transistor 18 turns ON, the voltage across the capacitor 14 is equal to the output voltage Vout, and the voltage across the inductor 22 is approximately equal to Vin−Vout, with the voltage drop across the transistor 18 being negligible. The current through the inductor 22 starts to increase linearly at the slope of (Vin−Vout)/Lp1, where the Lp1 is the inductance of the inductor 22. With the transistor 18 turned ON, the diode 12 is reverse-biased and no current flows through the diode 12. During this period the inductor 22 is storing energy in the form of a magnetic field.

With the transistor 18 turned OFF, the voltage source Vin is removed from the circuit and the inductor 22 functions as the voltage source through magnetic coupling with the inductor 16. The stored energy in the inductor 22 induces current through the inductor 16, and the induced current flows from the inductor 16 to the forward-biased diode 12 and the capacitor 14. During this period, the inductor 22 is discharging its stored energy into circuit. The current through the inductor 16 reduces linearly at the slope of Vout/Ls1. The capacitor C1 functions to smooth out voltage waveform as the inductor L1 charges and discharges in each cycle.

The voltage stress on the diode 12 reduces from Vin to (Vin−Vout)/N+Vout, where N is the turns ratio of the inductor 22 to the inductor 16. The forward voltage on the diode 12 can be much reduced. A typical forward voltage Vf of a 100V diode is around 0.7V while the forward voltage Vf of a 400V diode is around 1.5V. For a normal rectified AC voltage at 264 VAC, its maximum value is around 264×1.414=373.3V. In a conventional buck converter, the diode reverse breakdown voltage must be higher than 400V. By using the coupled inductor scheme in FIG. 3, the reverse bias voltage for the diode 12 can be reduced to below 100V such as 373.3/7+10=63V by assuming N=7 and Vout=10V. Enabling the use of a lower voltage rated diode results in reduced power dissipation across the diode 12. Further, the peak current through the transistor 18 is reduced from Ipk to Ipk/N. The reduction of peak current leads to a low RMS current. Considering the Rdson of the transistor is the same, the power dissipation on the transistor with the equation of Irms×Irms×Rdson is much reduced. If the power dissipation is kept the same, a transistor having a higher Rdson can be used, which reduces its cost. The conduction loss on the transistor 18 is also reduced. Each of these factors results in improved energy conversion efficiency. Additionally, material costs can be reduced since the voltage stress and current stress on semiconductors are much lower compared to conventional solutions.

Using the power converter of FIG. 3, the power dissipation of both the diodes power and the transistor are much reduced, and as such the conversion efficiency is improved. For the output voltage, it can be higher than 10V. The trade off is that higher output voltage may not gain as much as low voltage. The reason is that the ratio of diodes voltage drops divided by output voltage affects the efficiency. Higher output voltage means the improvement of diodes voltage drops on energy conversion efficiency becomes less.

The present application has been described in terms of specific embodiments incorporating details to facilitate the understanding of the principles of construction and operation of the power converter. Many of the components shown and described in the various figures can be interchanged to achieve the results necessary, and this description should be read to encompass such interchange as well. As such, references herein to specific embodiments and details thereof are not intended to limit the scope of the claims appended hereto. It will be apparent to those skilled in the art that modifications can be made to the embodiments chosen for illustration without departing from the spirit and scope of the application.

What is claimed is:

1. A power converter circuit to convert an input voltage to an output voltage, the power converter comprising:
a. a diode;
b. a first inductor coupled in series with the diode;
c. an output capacitor coupled to an input supply voltage and coupled in parallel to the serially coupled diode and first inductor, wherein the output voltage is a voltage across the capacitor;
d. a second inductor coupled in series to the capacitor, wherein the second inductor is magnetically coupled to the first inductor; and
e. a switch coupled in series to the second inductor and the input supply voltage.

2. The power converter circuit of claim 1 wherein the power converter circuit is configured to transfer energy from the input supply voltage to a load coupled to the capacitor and to store energy in the second inductor when the switch is ON.

3. The power converter of claim 2 wherein the power converter is configured to transfer energy from the second inductor to the load coupled to the capacitor when the switch is OFF.

4. The power converter of claim 1 wherein the diode is reverse-biased and no current flows through the serially coupled first inductor when the switch is ON.

5. The power converter of claim 4 wherein current through the second inductor rises linearly to a peak value when the switch is turned ON.

6. The power converter of claim 1 wherein the diode is forward-biased and current flows through the serially coupled first inductor when the switch is OFF.

7. The power converter of claim 6 wherein current through the first inductor decreases linearly when the switch is turned OFF.

8. The power converter of claim 1 wherein a cathode of the diode is coupled to a high side of the input supply voltage and to a first terminal of the capacitor, an anode of the diode is coupled to a first terminal of the first inductor, and a second terminal of the first inductor is coupled to a second terminal of the capacitor.

9. The power converter of claim 8 wherein a first terminal of the second inductor is coupled to the switch, and a second terminal of the second inductor is coupled to the second terminal of the capacitor.

10. The power converter of claim 1 wherein the switch is coupled to a low-side of the input supply voltage.

11. The power converter of claim 1 wherein the switch comprises a transistor.

12. The power converter of claim 1 further comprising a controller coupled to the switch.

13. A power converter circuit comprising:
a. a buck type converter including a diode, a capacitor, and an inductor, wherein the buck type converter is coupled to an input supply voltage and supplies a stepped-down output voltage across the capacitor;
b. a winding coupled in series to the capacitor and magnetically coupled to the inductor; and
b. a switch coupled in series to the coupled winding and to a low-side of the input supply voltage.

14. The power converter of claim 13 further comprising a controller coupled to the switch to turn the switch ON and OFF, wherein the power converter circuit is configured such that when the switch is ON current flows through the winding and not the inductor, thereby storing energy in the winding and delivering energy from the input supply voltage to a load coupled to the capacitor, and when the switch is OFF current flows through the inductor and not the winding, whereby the stored energy in the winding induces current in the inductor thereby delivering energy from the winding to the load coupled to the capacitor.
